(19) United States
(12) Patent Application Publication
(10) Pub. No.: US 2025/0280394 A1
(43) Pub. Date: Sep. 4, 2025

(54) NETWORK SLICE SMART ALLOCATION CONTROL SYSTEM

(71) Applicant: Rohit SENGUPTA, Reading (GB)

(72) Inventor: Rohit SENGUPTA, Reading (GB)

(21) Appl. No.: 19/067,196

(22) Filed: Feb. 28, 2025

(30) Foreign Application Priority Data
Mar. 1, 2024 (GB) 2403018.1

(51) Int. Cl. H04W 72/04; H04W 12/08; H04W 12/61; H04W 64/00

(52) U.S. Cl. CPC H04W 72/04; H04W 12/08; H04W 12/61; H04W 64/003

(57) ABSTRACT

A method of allocating a resource capacity of a mobile network. The method includes slicing the resource capacity into a restricted slice and a general slice. The allocation of the restricted slice is monitored with the sole goal of never letting the slice getting overwhelmed. Upon request from a user device, if there is sufficient resource capacity, a portion of the restricted slice is allocated to the user device. If there is insufficient resource capacity, the request is denied and placed into a queue to await access to restricted slice.

### BACKGROUND

The present invention relates to a method of allocating resources of a mobile network, particularly to specific mobile users. The method is most particularly for preventing a network slice from becoming overwhelmed. This ensures guaranteed quality of service. This is achieved by accommodating only as much as that which the network slice is dimensioned to accommodate. The invention further relates to a mobile-network resource allocation system, which may otherwise be referred to as a Smart Slice Allocation Control System.

A mobile network includes a plurality of Radio Area Network (RAN) nodes which connect to a core network via a transmission network. The transmission network may otherwise be known as backhaul. Each RAN node includes at least one antenna, or cell, to provide a Radio Area Network. User devices, also known as user equipment (UE), form a wireless connection, or radio link, with the antennas which allow portable user devices to connect wirelessly thereto via electromagnetic waves.

The user devices may, or may not, include a SIM card and could be, amongst other devices, a smart mobile telephone, a router, or an Internet of Things device.

Data can be sent and received across the RAN, and be transmitted from the RAN to the core network, or vice versa, via the transmission network. The transmission network may include a fibre or wireless connection. The core network manages, amongst other aspects, subscriber information and location.

The mobile network has a finite limit, or capacity, of resource, or bandwidth, which the user devices can access.

This resource capacity is limited at the RAN, the transmission network, and the core network. The RAN is particularly limited, since a mobile network operator is conventionally limited to operate only in the spectrum of frequencies which have been licenced from the government.

User devices are free to move between different cells of the mobile network, and therefore access the resource capacity of different antennas, or RAN nodes, and associated portions of the transmission network.

The more user devices which are accessing the resource capacity of a given antenna or associated transmission network portion, the lower the amount of resource or bandwidth each user device has. As such, in situations where a large number of user devices are in the same geographic location and so accessing the same antenna and/or transmission network portion, each user device may have access to only a low amount of resource or bandwidth. Therefore, the user device may be unable to perform functions which require a large amount of resource, such as streaming videos, or to access critical content.

In this way, individual location-specific resource capacities of the mobile network, each associated with at least one antenna, can be exceeded or congested at different times.

Mobile networks operate at least one Radio Access Technology (RAT), such as a fourth-generation technology standard (4G) and/or a fifth-generation technology standard (5G).

The resources of a 4G and 5G network can be divided into slices, as specified or enabled by a 3rd Generation Partnership Project, Release-15 onwards. A slice may constitute finite resources from the RAN, transmission network and core network to create a resource partition which can be allocated to a finite number of mobile users.

Each of the location-specific resource capacities, associated with one or more antennas, may have such slices.

At least one of the slices can be restricted, so that only authorised user devices can access the resource of the slice. As such, the authorised user devices can, in theory, benefit from a higher amount of resource than a general user since, proportionally, there should be a smaller number of authorised users for the restricted slice than for a general slice. Authorised users may include emergency services and persons or businesses paying a premium fee. From the RAN perspective, partitioned resources of a slice belong to individual antennas within a RAN node.

However, if there are a particularly large number of authorised users accessing the restricted slice of a given location-specific resource capacity, each authorised user may still only have access to a relatively low amount of resource and be unable to perform some functions. Only a certain percentage of RAN resources can be partitioned or sliced which can accommodate only a finite number of mobile users. Network slicing does not increase network resources, particularly RAN resources, rather it creates a partition of the network resources.

Conventionally, there is therefore no way to guarantee a user device a particular amount of resource or bandwidth for a given antenna, RAN node, or transmission network portion to maintain a desired quality of service (QoS).

The present invention seeks to provide a solution to this problem.

### BRIEF SUMMARY

According to a first aspect of the present invention, there is provided a method of allocating a resource capacity of a mobile network having a plurality of location-specific resource capacities and a plurality of antennas, each location-specific resource capacity being associated with at least one antenna and each comprising a plurality of slices including at least one slice which is a restricted slice and is not accessible to all user devices accessing the locality of the mobile network, the method comprising the steps of: a) at an allocation computing device associated with the mobile network, receiving at least one request which identifies at least one antenna and which is for at least one user device to access the restricted slice of the location-specific resource capacity associated with the or each said antenna, and allocating at least a portion of the restricted slice to the or each user device; b) determining an unallocated portion of the restricted slice based on a total resource capacity of the restricted slice and an allocated portion of the resource capacity of the restricted slice; c) receiving at least one further request for at least one further user device to access the restricted slice which exceeds the unallocated portion; d) denying the or each further request; e) and placing the or each further request into a queue to access the restricted slice.

As such, since user devices are allocated a portion of the location-specific resource capacity of the restricted slice, and the remaining resource capacity of said restricted slice is monitored, the restricted slice may be prevented or limited from becoming overwhelmed. If too many user devices request access to the restricted slice of the locality, or if the requests require an excessive amount of resource capacity, excess requests may be placed into a queue, rather than admitting the user devices to access the restricted slice of the locality. Therefore, the resources of the user devices already accessing the restricted slice for that locality remain unaffected, and those user devices can maintain a desired functionality provided by a guaranteed minimum quality of service, as defined by a bandwidth provided to the user. As user devices stop accessing the resource of the restricted slice of the locality and resource capacity becomes available, queued user devices may take their place.

User devices accessing the restricted slice have a guaranteed amount of resource, or bandwidth, since the amount cannot be depleted by user devices newly connecting to the restricted slice of the mobile network. Maintaining such a guaranteed resource amount may be important in a variety of scenarios, such as for emergency service use, business meetings, remote surgery, remote driving, or when streaming video.

The resource capacity and utilization per slice is allocated and monitored per location, identified by the antenna, and slice resources are owned by specific antennas, or their RAN node. Monitoring of slice utilization or enforcing slice admission control over a Tracking Area, which may be defined as a group of RAN nodes such as a city or town, or public land mobile network (PLMN), will not be beneficial as mobility of mobile users into or out of RAN nodes and cells cannot be controlled.

The user device does not gain access to the restricted slice of resource capacity of all compatible antennas across the mobile network. Instead, the user device would only gain access to designated antennas. A plurality of antennas in a given locality may be designated, such as those covering a region, city, post code area, neighbourhood, venue, or transport hub.

This invention does not aim to limit the number of registered users within a slice, neither does it aim to restrict the number of packet data unit (PDU) sessions (connections) established within the slice. The usage of a slice does not depend on how many users are registered within it or how many PDU sessions are established within the slice; slice usage depends on actual data usage (throughput in terms of bits per second) within the slice. A comparatively low number of heavy data users or connections could potentially overwhelm the slice in terms of how much capacity it has, and a higher number of low data users may not. Hence this invention aims to limit the “data usage” within the slice with a theoretical minimum guarantee.

Preferably, the or each request may include resource-amount data identifying a requested amount of the restricted slice, the portion of the restricted slice allocated to the user device being equal to the requested amount if it does not exceed the unallocated portion. Therefore, the user device may tailor its request to the necessary amount of resource, or bandwidth, required. Alternatively, each user device may be allocated the same amount of the restricted slice.

The amount may include separate uplink or downlink resource amounts, since mobile networks are generally optimized for downlink and hence have a higher downlink capacity over uplink capacity. The resource-amount data may also identify latency and jitter.

Optionally, the requested amount includes at least any one of 10 megabytes per second (mbps), 20 mbps, 50 mbps, and 100 mbps.

Beneficially, the or each request may include duration data identifying a requested duration of access to the restricted slice, the portion of the restricted slice being allocated to the user device for the said duration. Therefore, the user device may tailor its request to the necessary duration of access. Alternatively, each user device may be allocated access to the restricted slice for the same time period.

Additionally, the duration of access may be at least any one of 0.5 hour, 1 hour, 2 hours, 3 hours, 6 hours, 8 hours, 12 hours, and 24 hours.

Advantageously, the or each request may include time-start data identifying a time when the access to the restricted slice would start, the portion of the restricted slice being allocated to the user device at said time. By limiting the access time of the premium or restricted slice, more mobile users will get the opportunity to use the restricted slice and hence the guarantee that comes with it.

In a preferable embodiment, the location-specific resource capacity is of at least the antenna. The resource capacity may also be of an associated portion of the transmission network.

Preferably, the or each antenna is identified by identification of its Radio Access Network (RAN) node. Rather than identifying a specific antenna, one or more RAN nodes, which include relevant antennas, may instead be identified. Furthermore, a wider geographic location or route may be identified in the request, and the method may include the step of mapping RAN nodes or antennas within that location or along that route.

In case the mobile user device does not include the identification data for the RAN node and/or cell, there will be a method to fetch the mobile user's current location using a Network Application Programming Interface (API) (for example Location Reporting Event Monitoring API specified in 3gpp 29.522 Release 16).

Advantageously, the mobile network may include a first antenna and a second antenna having different geographic coverages, the first antenna having a first restricted slice, and the second antenna having a second restricted slice, the request including time-start data and duration data for access to the first restricted slice, and time-start data and duration data for access to the second restricted slice, the time-start data for the first and second restricted slices being different to each other. As such, the user device may transit between the coverage of two antennas, and maintain access to the restricted slice throughout.

Beneficially, the request includes planned journey-itinerary data for a user device, the planned journey-itinerary data including a departure location, arrival location and journey schedule, the method further comprising the steps of determining journey antennas between the departure location and arrival location, determining a time at which a user device will be at each journey antenna, and allocating at least a portion of the restricted slice of at least one of the journey antennas based on the time at which a user device will be at said journey antennas. Therefore, during the course of the journey, the user's device may be able to maintain access to a restricted slice when moving between antennas along the journey. Such a concept can also apply to a point of interest, postcode, city or town.

Additionally, the planned journey-itinerary data may be of a train journey. Alternatively, the journey-itinerary data may be of an emergency service journey, or a remote driving journey.

Beneficially, the mobile network may include a first antenna having an associated first restricted slice of resource capacity and a second antenna having an associated second restricted slice, the user device accessing the first antenna and being allocated at least a portion of the first restricted slice, the user device being handed over to the second antenna and a restricted-slice-handover request being made for the user device to access the second restricted slice. In this way, an attempt may be made for the user device to access the restricted slice when moving between cells of a mobile network, or between antennas of a mobile network.

Additionally, when the restricted-slice-handover request exceeds an unallocated portion of the second restricted slice, the restricted-slice-handover request may be denied and placed into a queue to access the second restricted slice. As such, when moving between cells of a mobile network, or between antennas of a RAN node, continued access to a restricted slice is not necessarily guaranteed. This prevents or limits the restricted slice of a given antenna becoming overwhelmed when an excessive number of user devices having prior restricted slice access connect to the antenna. In this case the user will be reallocated the general or default slice until resource becomes available in the second restricted slice governed by a queuing policy.

Optionally, the user device may be notified when the or each request is denied. This may provide the opportunity for the request to be amended or paused for a specified period of time thereby providing tangible and practical value to the mobile users.

Beneficially, when the requested amount of the restricted slice of the resource amount data exceeds the unallocated portion and the request is denied, the user device may be offered a reduced amount of the restricted slice which does not exceed the unallocated portion. In this way, the user device is provided the opportunity to access at least some resource of the restricted slice.

Advantageously, the or each request may include Radio Access Technology (RAT) data of the user device identifying a RAT of the user device, wherein allocating the portion of the restricted slice is based on the RAT data. The request is only validated if the user device has a compatible RAT to access the restricted slice.

Preferably, the or each request may include public-land-mobile-network-identification data of the user device identifying a mobile network operator of the user device, wherein allocating the portion of the restricted slice is based on the mobile network operator.

Preferably, the mobile network may operate fourth-generation technology standard (4G) and/or fifth-generation technology standard (5G). If the mobile user falls out of 4G or 5G coverage, for example having only a WiFi (RTM) connection or having a pre-4G connection, the service may be paused or aborted again providing greater efficiency. The system may track the user's reachability in this way.

According to a second aspect of the invention there is provided a mobile-network resource allocation system comprising: a mobile network having a plurality of location-specific resource capacities and a plurality of antennas, each location-specific resource capacity being associated with at least one antenna and each comprising a plurality of slices including at least one slice which is a restricted slice and is not accessible to all user devices accessing the mobile network; and an allocation computing device configured to receive at least one request which identifies at least one antenna and which is for at least one user device to access the restricted slice of at least one location-specific resource capacity associated with the or each said antenna and allocate at least a portion of said restricted slice to the or each user device, determine an unallocated portion of said restricted slice based on a total resource capacity of said restricted slice and an allocated portion of said restricted slice, receive at least one further request for at least one further user device to access said restricted slice which exceeds the unallocated portion, deny the or each further request, and place the or each further request into a queue to access said restricted slice.

The invention will now be more particularly described with reference to exemplary embodiments.

In the exemplary embodiment, there is provided a mobile-network resource allocation system. The mobile-network resource allocation system comprises a mobile network which has a plurality of Radio Area Network (RAN) Nodes which connect to a core network via a transmission network.

Each RAN Node includes at least one antenna to provide a RAN. User devices may form a wireless connection with the antennas via a Radio Access Technology (RAT), such as via fourth-generation technology standard (4G) and/or fifth-generation technology standard (5G). 5G antennas may be either standalone (SA) 5G antennas or non-standalone (NSA) 4G and 5G antennas using long-term evolution (LTE) architecture.

Each antenna may be mounted to a mast or tower of the RAN node, and each antenna may be a cell antenna or sector antenna, such as one providing 120° of coverage. As such, each RAN node may have up to three antennas to provide 360° of coverage, although it will be appreciated that this may not necessarily be the case.

For 4G, each RAN node may conventionally be referred to as an eNodeB. For 5G, each RAN node may conventionally be referred to as a gNodeB.

The mobile network has a resource capacity, or bandwidth. The RAN across all antennas may have a total RAN resource capacity. A portion of the total RAN associated with each antenna may also have a resource capacity. As such, each antenna may have a given resource capacity. The resource capacity of a given antenna may be, for example, 5 gigabytes per second (gbps). It will be appreciated that different resource capacities will be considered, as based on a given Radio Access Technology and associated spectrum, such as Mid Band, Low Band and High Band.

The transmission network may similarly have a total bandwidth, or resource capacity. Furthermore, the core network may also have a total bandwidth.

The resource capacity of: one or more RAN nodes, an associated transmission network, or portion thereof, and/or an associated core network, or portion thereof, may be referred to as a location-specific resource capacity. The term location-specific resource capacity may therefore refer to a resource capacity of a localised portion of the mobile network, and not the resource capacity of the entire mobile network.

The user devices may include mobile telephones, also known as cellular telephones, along with other wireless devices having an antenna for wireless communication with the antennas of the RAN nodes. Each user device may include a display, for displaying notifications, and a user control or data input means.

The RAN nodes are spaced apart from each other, each providing an area of geographic coverage.

The transmission network between the RAN nodes and the core network may comprise a plurality of data transmission cables, such as fibre optic cables.

The mobile-network resource allocation system further includes an allocation computing device, which may include one or more separate computing devices, such as servers. The allocation computing device may include at least a memory device for storing one or more databases thereon, and a processor.

The allocation computing device may be communicatively connectable, such as via wireless communication and/or the internet, with the user devices such as via a mobile application or app, for sending notifications to the user devices and sending requests from the user devices to the allocation computing device.

In use, the resource capacity of each of the RAN, transmission network, and/or core network may be split or partitioned into a plurality of slices. As such, there may be at least two slices: a restricted slice which is not accessible to all user devices accessing the mobile network; and a general slice which is accessible to all user devices accessing the mobile network. The restricted slice may be accessible only to authorised user devices.

The resource capacity of the RAN of a given antenna may be split. For example, the antenna may have a resource capacity of 5 gbps, the restricted slice having a bandwidth of 1 gbps and the general slice may have a bandwidth of 4 gbps.

The exemplary embodiment may be used as per the following examples.

### Example 1

In a first example, the user device may send a request to the allocation computing device for the user device to access the restricted slice of a location-specific resource capacity associated with at least one antenna of the mobile network. This is not for accessing the restricted slice of the entire mobile network, but for accessing the restricted slice or slices of a selection of one or more antennas of the mobile network, and the associated portions of the transmission network and core network.

This request may be sent via an interface of the allocation computing device. For example, the user device may include a computer program, such as a mobile application or app, installed thereon for communicating with the allocation computing device. Alternatively, the user device may access a website for communicating with the allocation computing device. The computer program or website may include a plurality of data entry fields for entering relevant data to be communicated to the allocation computing device in the request. The relevant data may include, but not be limited to, the type of usage, for example download and upload levels given in mbps, Radio Access Type and Location, for example gNodeB ID, eNodeB ID and/or Cell ID, the identity of the mobile user as given by the Mobile Station International Subscriber Directory Number (MSISDN), the service provider of the mobile user identified by the PLMN ID, Radio Signal Levels, and Neighbouring Antenna or Cell details.

The user device may have first been pushed or offered the allocation of the resource capacity of the restricted slice by the allocation computing device notifying the user of its availability upon connecting to a suitable antenna.

The request may include resource-amount data identifying a requested amount of the resource capacity of the restricted slice to be allocated to the user device. For example, the requested amount may include at least any one of 10 megabytes per second (mbps), 20 mbps, 50 mbps, and 100 mbps or a type of application which can be mapped to bandwidth.

The request may include duration data identifying a duration of access to the restricted slice for the user device. For example, the requested duration may include at least any one of 0.5-hour, 1 hour, 2 hours, 3 hours, 6 hours, 8 hours, 12 hours, and 24 hours.

The request may include time-start data identifying a time when the access to the restricted slice would start. The time may be immediately, or may be some time or date in the future.

The request may include Radio Access Technology (RAT) data of the user device identifying a RAT of the user device. For example, the RAT data may include an indication of whether the RAT of the user device is 4G and/or 5G compatible.

The request also includes antenna identification data, identifying the antenna or antennas, and associated portion or portions of the transmission network, having the restricted slice or restricted slices of the location-specific resource capacity which the user device would access. For a stationary user, this may be provided as a single antenna, or the antennas of a single RAN node. This may also be considered to be location data.

Alternatively, the antenna identification data be provided as a group of antennas in a point of interest, such as in a geographic area, for example a city, post code area, region, neighbourhood, venue, or transport hub. The antenna identification data may instead be provided as a postcode, rail route, point of interest, post code, city or town which can be mapped to a group of antennas by the allocation computing device.

The antenna identification data may be determined automatically, for example via determining the antenna to which the user device is connected and/or by extracting the location information from the mobile network operator's core network using Standard Network APIs (for example Location Reporting Event Monitoring API specified in 3gpp 29.522 Release 16).

Having received the request, the allocation computing device may then determine whether to allow or deny the request by following a validation cycle.

The allocation computing device determines an unallocated portion of the resource capacity of the restricted slice based on the total resource capacity of the restricted slice and an allocated portion of the resource capacity. This will be for the particular antenna or antennas, and associated portion or portions of the transmission network identified in the antenna identification data which make up the location-specific resource capacity.

The allocation computing device may determine the unallocated portion via the allocation computing device accessing a database which includes information or data of the allocation of the resource capacity of the restricted slice. Such data may include the resource-amount data, duration data, time-start data and/or antenna identification data of current and/or future validated requests.

The request is validated or admissible depending on at least one factor.

Firstly, the request is validated if the RAT data indicates that the user has a compatible user device for accessing the restricted slice, for example, 4G and/or 5G RAT.

The request is also validated if there is a sufficient amount of unallocated location-specific resource capacity of the restricted slice or slices, as identified by the antenna identification data, for the time period, as identified by the duration data and time-start data.

If the criteria are met and the request is validated, the allocation computing device allocates at least the requested portion of the location-specific resource capacity of the relevant restricted slice or slices. The allocation computing device then records this on the relevant database.

The user may then access the relevant restricted slice or slices, having guaranteed access for the relevant time period.

All functions of the user device may have access to the restricted slice or slices. However, it will be appreciated that only a limited number of functions of the user device may have access to the restricted slice. For example, only video streaming computer programs of the user device may have access to the restricted slice.

As the user device reaches the end of the allotted duration, the user device may be notified by the allocation computing device and offered the opportunity to renew or extend the request for an additional duration. This is dependent upon there being sufficient resource capacity in the unallocated portion for the additional duration.

If the user does not renew or extend the request, there is insufficient resource capacity to accommodate the additional duration, and/or there are queued users, then the access to the restricted slice is terminated, increasing the unallocated portion of the restricted slice. The user device's access may be limited to the general or default slice.

Returning to the initial request of the user device, if it is determined that there is an insufficient amount of the location-specific resource capacity in the unallocated portion of the restricted slice for the designated time period, the allocation computing device may deny the request.

The allocation computing device may send a notification to the user device regarding the denied request.

The request may then be put into a queue with other denied requests. The allocation computing device may communicate a position in the queue to the further device and/or an expected time of reaching a zeroth position of the queue and accessing the restricted slice.

As user devices having allocated portions of the restricted slice reach the end of the allotted durations and have their access terminated, increasing the unallocated portion, the queued user devices may have access to the restricted slice granted. The queue may be a “first-in first-out” queue or based on mobile operator prioritization policy, for example prioritize critical and government services.

If the unallocated portion of the restricted slice is non-zero, but is still insufficient to meet the requested amount, instead of immediately placing the user into the queue, the allocation computing device may offer to the user device, via a notification, a reduced amount of resource capacity. The user device may choose to accept this offer in the meantime, and/or be placed in the queue to access the full or excess amount of resource capacity when this becomes unallocated.

Similarly, if there is a sufficient unallocated portion for only a reduced portion of the requested duration, or a slightly different duration, the user device may be offered this reduced and/or different duration in a similar way.

Additionally or alternatively, if there is a sufficient unallocated portion for only some of the identified antennas and associated portions of the transmission network, the user device may be offered this more limited access to the restricted slice or slices in a similar way.

If the user device is in the queue, and is connected to a different antenna associated with a different location-specific resource capacity for which there is a sufficient unallocated portion of the restricted slice, the user device may be automatically allocated the requested portion of the restricted slice.

The guaranteed access of the user device to the relevant restricted slice or slices is limited to the identified antenna or antennas, and/or associated portions of the transmission network.

If the user device has been allocated access to the restricted slice of a first antenna or set of antennas, and is handed over to a second antenna, and associated portion of transmission network, having a restricted slice to which access has not been granted, a corresponding further request may be made to the allocation computing device to access the restricted slice of the second antenna. Such a further request may be automatically made by the further user device.

The handover between antennas may include intra-gNodeB, intra-eNodeB, inter-gNodeB, inter-eNodeB, inter TAC or inter-RAT handovers.

The computation allocation system will keep track of users' mobility within the mobile network to take such decisions.

This corresponding further request may be granted or denied in a similar manner as discussed previously.

If the further request is granted, then the user device may access the restricted slice of the second antenna. If the request is denied, the further request may be placed into a corresponding queue for access to the restricted slice of the second antenna, and the user device may access only the general slice of the resource capacity of the second antenna.

As such, if the user device moves between antennas of the mobile network, the user device may only maintain access to the restricted slice of the new antenna, if a sufficient and relevant unallocated portion is available. This therefore makes best efforts to maintain a level of access for the moving user device, whilst preserving the portion of resource capacity of pre-existing users accessing the restricted slice.

The user device having been handed over to a second antenna, the allocated portion of the restricted slice of the first antenna or set of antennas may be maintained or reserved for the user device, or may be cancelled and so returned to the unallocated portion.

If, however, the mobile user has requested for a collection or group of antennas identified by the identification data and the allocation computing device has successfully allocated the slice to the mobile user over the entire geographical location comprising of the collection or group of antennas identified by the identification data, then bandwidth can be guaranteed to the mobile user during mobility within that specified geographical location.

### Example 2

In a second example which may be similar to the first example, the or each request may be made on behalf of a user device by a third-party organisation or device.

The request may be made by an organisation associated with a plurality of user devices. The organisation may be a business or a public or government organisation, such as an emergency service organisation.

The request may be time-or event-dependent, such as the emergency service organisation requesting access for the user device of an emergency service worker when the emergency service worker is assigned to an emergency operation.

The request may be made by a third-party computer program, such as a unified communications computer program.

In the instance that the request is made on behalf of a user device, the MSISDN and/or International Mobile Subscriber Identity (IMSI) may be provided in the request. The location of the user device may also be provided, to determine the antenna identification data.

The other steps of the second example may be similar or identical to the first example.

### Example 3

In a third example which may be similar or identical to the first example, access for a user device to the restricted slices of a plurality of different location-specific resource capacities associated with different antennas, and associated transmission network portions, may be provided at different times for optimising the allocation of a user device on a planned journey.

In this instance, the request may include planned journey-itinerary data having a departure location, arrival location and journey schedule. The journey schedule may include the expected departure time and the expected arrival time. The journey-itinerary data may also include anticipated speeds of travel.

An expected route between the departure location and the arrival location may be determined. This may be pre-determined and provided to the allocation computing device along with the journey-itinerary data, or may be determined by the allocation computing device.

The allocation computing device, or another computing device, may then determine the antennas between the departure location and arrival location. In other words, the antennas along the expected route may be determined. The antennas may not be exactly on the route, instead being the most suitable antennas proximal to the route for providing RAN with the user device when travelling along the route. Such antennas may be referred to as journey antennas.

The time at which the user device may be connected to each journey antenna may then be determined by the allocation computing device, based on the journey schedule and/or the speed of travel. The time may include a buffer or grace period for accommodating deviations from the journey schedule.

The allocation computing device may then determine whether the amount of restricted slice requested by the user device would exceed the unallocated portion of the restricted slice of each journey antenna, and associated portions of the transmission network, at the time the user device is expected to be connected to each journey antenna.

Assuming that the unallocated portions are not exceeded, the request is granted and the allocation computing device may allocate the relevant portion of the restricted slice of each journey antenna to the user device for the relevant time period.

If the request exceeds the unallocated portion of one or more of the journey antennas, and associated portions of the transmission network, the request may be denied, which may be transmitted to the user device and/or the user device may be offered to proceed with the allocation of the restricted slice of available journey antennas only.

During the course of the journey, once the user device has been handed over from a given journey antenna, the allocation computing device may terminate the allocation of the restricted slice of the given journey antenna.

If the user device deviates from the expected route, and is handed over to a non-journey antenna, a further request may be made to the allocation computing device for access to the restricted slice of the non-journey antenna in a similar way as previously described.

Alternatively, the expected route may be re-determined based on the deviation, new journey antennas may be determined, and times which the user device is expected to be at the new journey antennas may be calculated. The allocation computing device may then determine and allocate, if validated, at least a portion of the restricted slice of the new journey antennas to the user device at the relevant times. The allocations of the previous journey antennas may be terminated.

In the third example, the journey may be, for example, a rail journey. As such, the departure location may the departure station, the arrival location may be the arrival station, and the journey schedule may include the departure time and/or arrival time. The remaining timings of the journey schedule may be determined by a rail journey timetable, which may be accessed automatically by the allocation computing device from a rail journey provider.

Alternatively, the journey may be a road vehicle journey, in particular a journey of an emergency service vehicle or a journey of a vehicle which is being remotely driven from beyond line-of-sight.

Other steps of the third example may be similar or identical to the first or second example.

In any example, it will be appreciated that payment may accompany any of the requests. As such, the request may include payment details associated with the user device, and the allocation computing device or another computing device may process the payment details upon validation of the request. Alternatively, upon validation of the request, the allocation computing device may temporarily reserve the portion of restricted slice and notify the user device that payment is required. Access to the reserved portion of the restricted slice may be provided upon provision of payment details.

### BRIEF DESCRIPTION OF THE SEVERAL VIEWS OF THE DRAWINGS

Reference may also be made to the accompanying drawings, in which:

FIG. 1 illustrates a prior art system;

FIG. 2 outlines a first representation of an embodiment of a mobile-network resource allocation system in accordance with a second aspect of the present invention;

FIG. 3 outlines a second representation of the mobile-network resource allocation system of FIG. 2;

FIG. 4 outlines an application programming interface (API) of the mobile-network resource allocation system of FIG. 2; and

FIG. 5 outlines a third representation of the mobile-network resource allocation system of FIG. 2.

### DETAILED DESCRIPTION

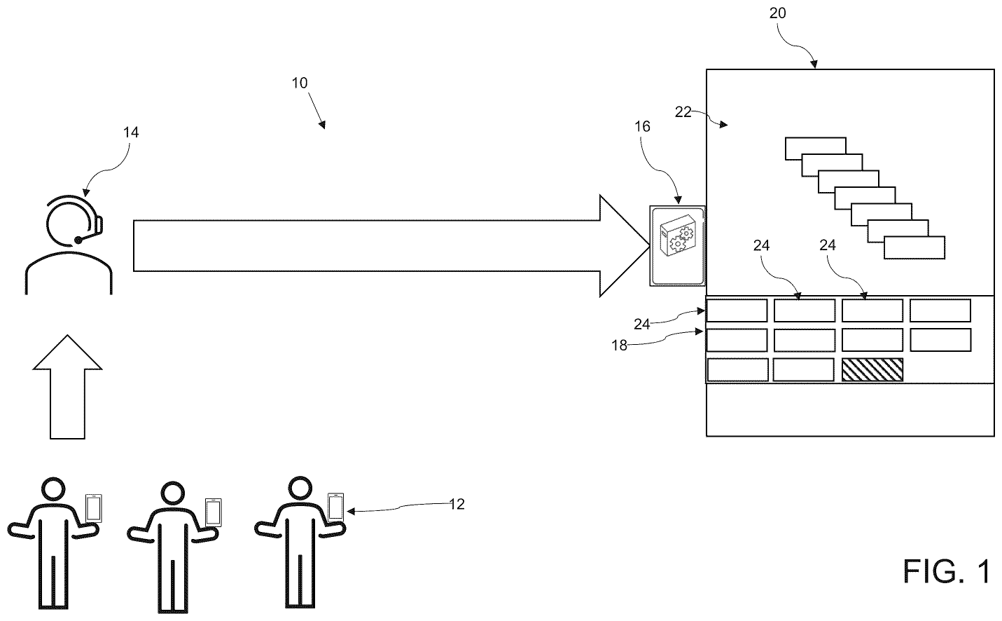

Referring to FIG. 1, in a conventional or prior art mobile-network resource allocation system 10, a plurality of users having user devices 12 may be onboarded via a mobile phone operator 14 via an information technology and business support system 16 to become authorised to access the restricted slice 18 of a location-specific resource capacity 20, which may also have a general or default slice 22.

Each user may wish to have resource or bandwidth amount 24, equating to 10 mbps, for example. The restricted slice 18 associated with a single antenna may have a resource capacity or bandwidth of 100 mbps, for example. Once at least eleven users have each connected to the restricted slice 18 associated with the single antenna, each user would be unable to have access to their desired amount of resource or bandwidth. This is since the resource capacity or bandwidth of 100 mbps would be split with eleven users, resulting in less than 10 mbps each.

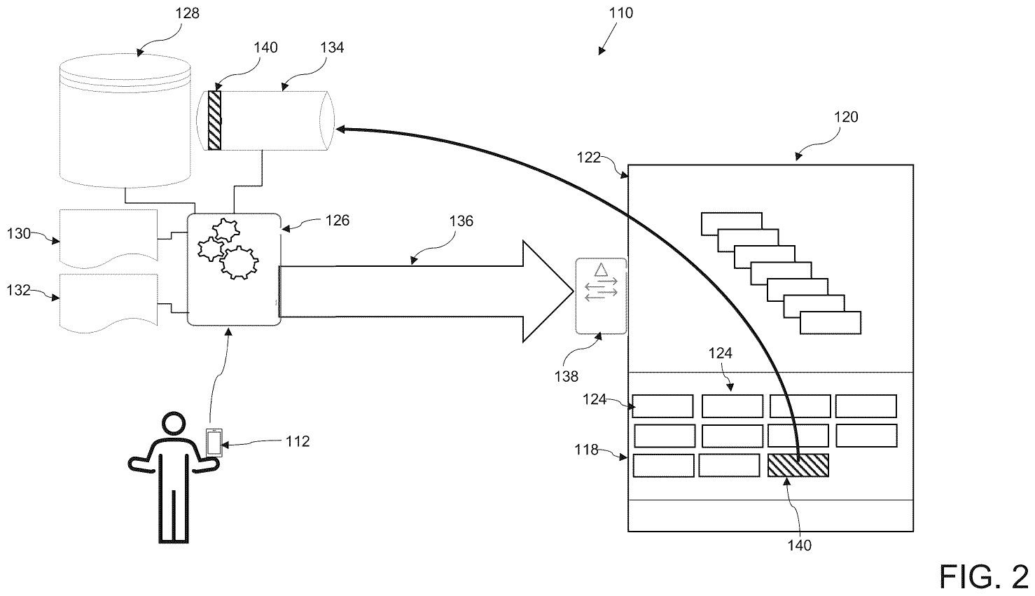

Referring now to FIG. 2, there is shown a first representation of a mobile-network resource allocation system 110. Here a user device 112 may communicate with an allocation computing device 126. The allocation computing device 126 may comprise or communicate with a dynamic slice utilisation database 128, a database of customer products 130, a customer slicing configuration 132, and a first in first out (FIFO) management database 134. When the user device 112 communicates with the allocation computing device 126 to request access to the restricted slice 118 of a location-specific resource capacity 120, which also has a general or default slice 122, an API request 136 may be triggered which may communicate with the mobile network and/or the location-specific resource capacity 120 via a Network Exposure Function (NEF) or Service Capability Exposure Function (SCEF) 138.

The user device 112 may make a request to the allocation computing device for a certain amount of bandwidth, resources, or QoS via requesting a particular product. Such products may include remote working/work-on-the-go, cloud gaming, news reporting, live streaming, conference calls, remote teaching, and a home broadband product, which equates to the bandwidth required by a typical home. Each product may equate to a different amount of guaranteed bandwidth or QoS from the restricted slice, and/or may be integrated with different applications or computer programs.

In the instance that the restricted slice is already at capacity, for example if the restricted slice has a resource capacity of 100 mbps and there are ten requests 124 already each allocated 10 mbps, the user's request 140 for access will be placed into a queue via the first in first out management database 134.

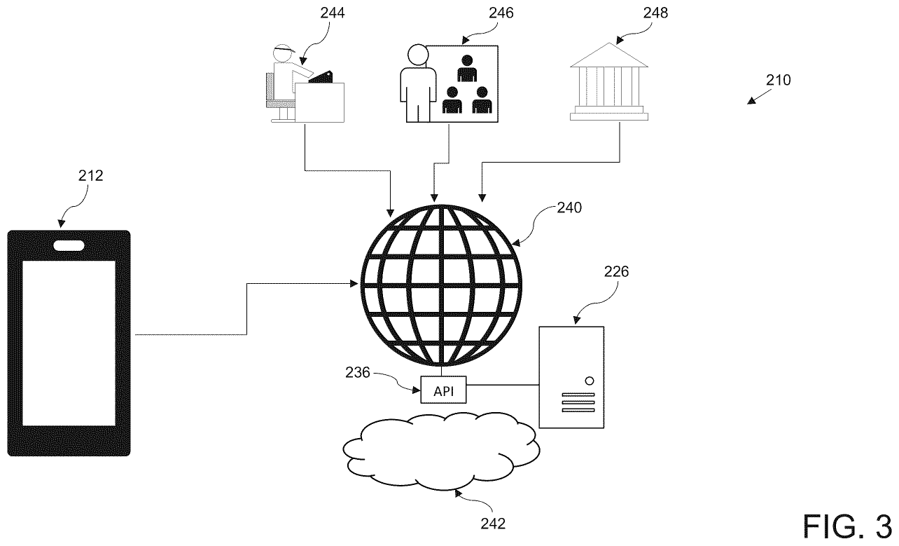

Referring now to FIG. 3, there is shown a second representation of a mobile-network resource allocation system 210.

The user device 212 may submit a request to the allocation computing device 226 to access the restricted slice.

The request may include a desired service, selected by the user. The desired service may be, for example, access to a restricted slice based on the current location, a journey, such as a railway journey, a city, or a point of interest. The journey may include details, as per Example 3 above, such as the type of journey, the route, and the date and time of the journey.

The request may also include data relating to the MSISDN, RAT, Subscriber Type (Post/pre-pay), Signal Level (dBm), Registered Slice (for example Network Slice Selection Assistance information [NSSAI]), Product/Service, Product/Service Type, Location (as indicated by, for example, the gNodebld and/or CellId), and PLMN ID (Mobile Network Operator/Communications Service Provider Identifier).

The allocation computing device may communicate with the mobile network 240, such as the Operator Core Network 242, which may be done via or comprise a 3gpp NEF and/or Unified Data Repository (UDR).

The communication may be via an API 236 with the following details:
API-1: Custom
   Slice Change
   RFSP/SPID+ABMR Change
API-2: TS29122_MonitoringEvent
   LOCATION_REPORTING
   UE_REACHABILITY
   API_SUPPORT_CAPABILITY (CN Type Change)
API-3: TS29522_ServiceParameter.yaml
   urspGuidance
API-4: TS29122_AsSessionWithQoS.yaml
   flowInfo
   QoS

The API may include or manage at least one of a Mobile App to Web App; Custom API to change slice; Event Exposure Monitoring Events: Location Reporting etc.; Traffic influence: AF Guidance URSP, AS Session QoS etc.; Databases & Tables; Mobile Network Operator/Communications Service Provider (MNO/CSP) Data—Configure customer data like product/service list & slice capacity per location (gNb/eNb); Slice Management, Queue Management & Session Management; Call Data Record, Alarms & Key Performance Indicator (KPI); Business Logic; Validation of request from Mobile App like Slice Onboard, Inter-RAT mobility; Slice allocation based on free capacity per slice per location; Service Expiry, Queue & Mobility; Map Journey, POI, Postcode, City/Town to collection of gNodeB/eNodeB IDs; Trigger APIs, manage/update databases; Workflows; User Request, Product/Service Selection, Product/Service Expiry, Manage user (UE) mobility and queue; Front End; MNO/CSP Data Entry, Edit & View; Admin controls, view Database Tables, Dashboard, Set parameters; and Configure and Trigger Simulators.

Having determined whether access to the restricted slice is possible, the response from the allocation computing device 226 to the user device 212 may include: a Validation Result, Product & Service List, Service Selection Result, Notification—Queue, Notification—Mobility, Notification—Service Expiry, and/or Notification—Service Paused.

Instead of the request being derived from a mobile device 212 of an individual user 244, the request may derive from a company 246, or an application or computer program 248, such as a banking, video conferencing, or streaming application.

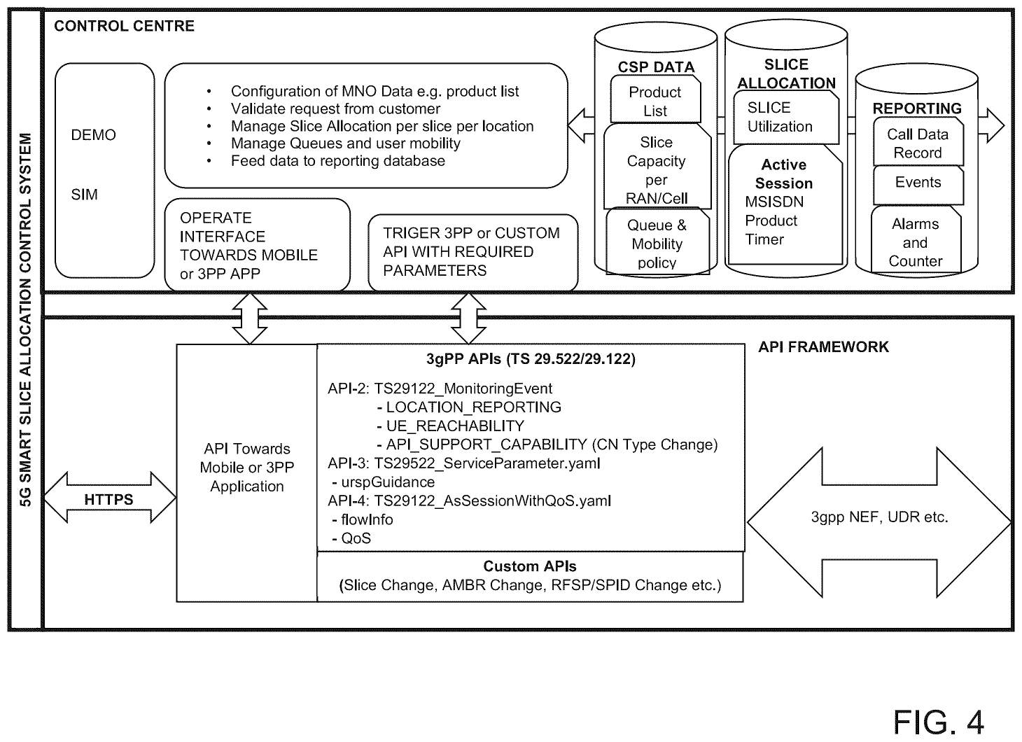

Referring now to FIG. 4, there is shown a third representation of the mobile-network resource allocation system.

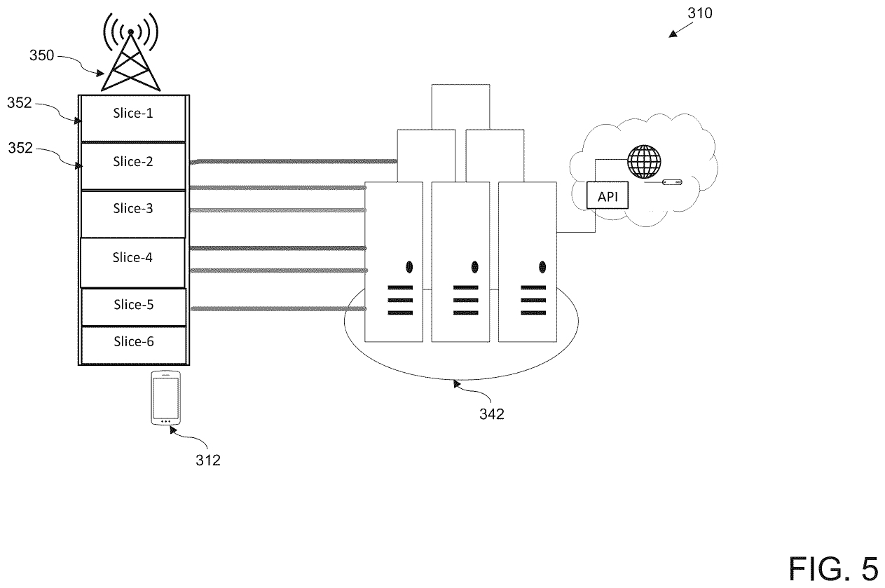

Referring now to FIG. 5, there is shown a fourth embodiment of a mobile-network resource allocation system 310. The location-specific resource capacity associated with the or each said antenna 350 may have different slices 352 for different functions of the network workload. For example, there may be a slice to provide streaming services, or home working services. The user device 312 may obtain access to the relevant slice by making a request to the allocation computing device for a particular product.

The 5G core network 342 may include an Access & Mobility Management Function, a Session Management Function, a Network exposure function, and a Network exposure function.

It is therefore possible to provide a method and system for allocating the resource capacity of a mobile network. The resource capacity is sliced into a restricted slice and a general slice. The available resource capacity of the restricted slice is monitored. User devices may be allocated a portion of the resource capacity of the restricted slice upon request, assuming that there is sufficient resource capacity to accommodate their request. If not, the request is denied and placed into a queue, so that the allocation of the resource capacity of the restricted slice for existing users is maintained.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

I/we claim:

1. A method of allocating a resource capacity of a mobile network having a plurality of location-specific resource capacities and a plurality of antennas, each location-specific resource capacity being associated with at least one antenna and each comprising a plurality of slices including at least one slice which is a restricted slice and is not accessible to all user devices accessing the locality of the mobile network, the method comprising the steps of:
a) at an allocation computing device associated with the mobile network, receiving at least one request which identifies at least one antenna and which is for at least one user device to access the restricted slice of the location-specific resource capacity associated with the or each said antenna, and allocating at least a portion of the restricted slice to the or each user device;
b) determining an unallocated portion of the restricted slice based on a total resource capacity of the restricted slice and an allocated portion of the resource capacity of the restricted slice;
c) receiving at least one further request for at least one further user device to access the restricted slice which exceeds the unallocated portion;
d) denying the or each further request; and
e) placing the or each further request into a queue to access the restricted slice.

2. A method as claimed in claim 1, wherein the or each request includes resource-amount data identifying a requested amount of the restricted slice, the portion of the restricted slice allocated to the user device being equal to the requested amount if it does not exceed the unallocated portion.

3. A method as claimed in claim 2, wherein the requested amount includes at least any one of 10 megabytes per second (mbps), 20 mbps, 50 mbps, and 100 mbps.

4. A method as claimed in claim 1, wherein the or each request includes duration data identifying a requested duration of access to the restricted slice, the portion of the restricted slice being allocated to the user device for the said duration.

5. A method as claimed in claim 4, wherein the duration of access is at least any one of 0.5 hour, 1 hour, 2 hours, 3 hours, 6 hours, 8 hours, 12 hours, and 24 hours.

6. A method as claimed in claim 1, wherein the or each request includes time-start data identifying a time when the access to the restricted slice would start, the portion of the restricted slice being allocated to the user device at said time.

7. A method as claimed in claim 1, wherein the location-specific resource capacity is of at least the antenna.

8. A method as claimed in claim 1, wherein the or each antenna is identified by identification of its Radio Access Network (RAN) node.

9. A method as claimed in claim 1, wherein the mobile network includes a first antenna and a second antenna having different geographic coverages, the first antenna having a first restricted slice, and the second antenna having a second restricted slice, the request including time-start data and duration data for access to the first restricted slice, and time-start data and duration data for access to the second restricted slice, the time-start data for the first and second restricted slices being different to each other.

10. A method as claimed in claim 1, wherein the request includes planned journey-itinerary data for a user device, the planned journey-itinerary data including a departure location, arrival location and journey schedule, the method further comprising the steps of determining journey antennas between the departure location and arrival location, determining a time at which a user device will be at each journey antenna, and allocating at least a portion of the restricted slice of at least one of the journey antennas based on the time at which a user device will be at said journey antennas.

11. A method as claimed in claim 10, wherein the planned journey-itinerary data is of a train journey.

12. A method as claimed in claim 1, wherein the mobile network includes a first antenna having an associated first restricted slice and a second antenna having an associated second restricted slice of resource capacity, the user device accessing the first antenna and being allocated at least a portion of the first restricted slice, the user device being handed over to the second antenna and a restricted-slice-handover request being made for the user device to access the second restricted slice.

13. A method as claimed in claim 12, wherein, when the restricted-slice-handover request exceeds an unallocated portion of the second restricted slice, denying the restricted-slice-handover request and placing the or each restricted-slice-handover request into a queue to access the second restricted slice.

14. A method as claimed in claim 1, wherein the user device is notified when the or each request is denied.

15. A method as claimed in claim 1, wherein, when the requested amount of the restricted slice of the resource amount data exceeds the unallocated portion and the request is denied, the user device is offered a reduced amount of the restricted slice which does not exceed the unallocated portion.

16. A method as claimed in claim 1, wherein the or each request includes Radio Access Technology (RAT) data of the user device identifying a RAT of the user device, wherein allocating the portion of the restricted slice is based on the RAT data.

17. A method as claimed in claim 1, wherein the or each request includes public-land-mobile-network-identification data of the user device identifying a mobile network operator of the user device, wherein allocating the portion of the restricted slice is based on the mobile network operator.

18. A method as claimed in claim 1, wherein the mobile network operates fourth-generation technology standard (4G) and/or fifth-generation technology standard (5G).

19. A mobile-network resource allocation system comprising:
a mobile network having a plurality of location-specific resource capacities and a plurality of antennas, each location-specific resource capacity being associated with at least one antenna and each comprising a plurality of slices including at least one slice which is a restricted slice and is not accessible to all user devices accessing the mobile network; and
an allocation computing device configured to
receive at least one request which identifies at least one antenna and which is for at least one user device to access the restricted slice of the location-specific resource capacity associated with the or each said antenna and allocate at least a portion of said restricted slice to the or each user device,
determine an unallocated portion of said restricted slice based on a total resource capacity of said restricted slice and an allocated portion of said restricted slice,
receive at least one further request for at least one further user device to access said restricted slice which exceeds the unallocated portion,
deny the or each further request, and
place the or each further request into a queue to access said restricted slice.
